(19) United States
(12) Patent Application Publication
(10) Pub. No.: US 2025/0205608 A1
(43) Pub. Date: Jun. 26, 2025

(54) METHOD AND SYSTEM FOR VIRTUAL RESOURCE INTERACTION, MEDIUM, AND PROGRAM PRODUCT

(71) Applicant: SHANGHAI LILITH TECHNOLOGY CORPORATION, Shanghai (CN)

(72) Inventors: Xiao WEI, Shanghai (CN); Chenghan JIANG, Shanghai (CN); Shuxi Liao, Shanghai (CN); Liang Zhou, Shanghai (CN); Xun Zhou, Shanghai (CN); Xintian Chen, Shanghai (CN)

(21) Appl. No.: 18/850,200

(22) PCT Filed: Mar. 15, 2024
(86) PCT No.: PCT/CN2024/081808

§ 371 Date: Mar. 11, 2025

(30) Foreign Application Priority Data
Dec. 22, 2023 (CN) 202311787925.0

(51) Int. Cl. A63F 13/73; A63F 13/35

(52) U.S. Cl. CPC A63F 13/73; A63F 13/35

(57) ABSTRACT

The present disclosure relates to the field of human-computer interaction, and in particular, to a method and system for virtual resource interaction, a medium, and a program product. The method of the present disclosure includes: transmitting, by a client, a first acquisition request and first verification data to a server to request acquisition of a virtual progression resource of a first virtual character; transmitting, by the server, the virtual progression resource of the first virtual character to the client based on the first acquisition request and the first verification data; transmitting, by the client, a second acquisition request and second verification data to the server to request acquisition of a virtual reward resource of the first virtual character; and transmitting, by the server, the virtual reward resource of the first virtual character to the client based on the second acquisition request and the second verification data.

### CROSS-REFERENCE TO RELATED DISCLOSURES

This application is a national stage application of PCT international application PCT/CN2024/081808 filed on Mar. 15, 2024, entitled “METHOD AND SYSTEM FOR VIRTUAL RESOURCE INTERACTION, MEDIUM, AND PROGRAM PRODUCT”, which claims priority to Chinese patent application No. 2023117879250, filed on Dec. 22, 2023, the entire contents of which are incorporated herein by reference.

### TECHNICAL FIELD

The present disclosure relates to a field of human-computer interaction, and in particular, to a method and system for virtual resource interaction, a medium, and a program product.

### BACKGROUND

With advances in computer technology and network technology, video games such as Role-Playing Game (RPG), Card Game (CAG), and Simulation Game (SLG) have become popular. In these games, a player typically controls one or several virtual characters in a virtual world to play the game, level up, collect equipment, and complete a task set by the game, etc.

In these games, character progression is typically one of the sources of fun. The game needs to provide various ways to reward character progression, such as issuing in-game items, achievement badges, or real-life benefits. Rewarding character progression can give the player a sense of achievement and enhance their enjoyment in playing the game.

### SUMMARY

Embodiments of the present disclosure disclosed a method for virtual resource interaction. The method includes:
transmitting, by a client, a first acquisition request and first verification data to a server to request acquisition of a virtual progression resource of a first virtual character;
transmitting, by the server, the virtual progression resource of the first virtual character to the client based on the first acquisition request and the first verification data;
transmitting, by the client, a second acquisition request and second verification data to the server to request acquisition of a virtual reward resource of the first virtual character; and
transmitting, by the server, the virtual reward resource of the first virtual character to the client based on the second acquisition request and the second verification data.

In some embodiments, the first verification data indicates the current number of the first virtual characters at the client, and the transmitting, by the server, the virtual progression resource of the first virtual character to the client includes:
verifying, by the server, whether the current number of the first virtual characters satisfies the number of the first virtual characters required for the request virtual progression resource;
determining, by the server, the number of the virtual progression resources to be transmitted, and updating the current number of the first virtual characters, when the current number of the first virtual characters satisfies the number of the first virtual characters required;
transmitting, by the server, the virtual progression resource and the updated current number of the first virtual character to the client; and
synchronizing, by the client, the current number of the virtual progression resources and the current number of the first virtual characters at the client.

In some embodiments, the second verification data indicates a current progression level of the first virtual character at the client, and transmitting by the server, the virtual reward resources of the first virtual character to the client includes:
verifying, by the server, whether the current progression level of the first virtual character satisfies the progression level of the first virtual character required for the requested virtual reward resource;
determining, by the server, the virtual reward resource to be transmitted when the current progression level of the first virtual character satisfies the progression level of the first virtual character required;
transmitting, by the server, the virtual reward resource to the client; and
synchronizing, by the client, the virtual reward resource at the client.

In some embodiments, the method further includes:
transmitting, by the client, a third acquisition request and third verification data to the server to request acquisition of the progression level of the first virtual character; and
transmitting, by the server, the progression level of the first virtual character to the client based on the third acquisition request and the third verification data.

In some embodiments, the third verification data indicates the current number of the virtual progression resources of the first virtual character at the client and the current progression level of the first virtual character, and transmitting, by the server, the progression level of the first virtual character to the client includes:
verifying, by the server, whether the current number of the virtual progression resources of the first virtual character satisfies the number of the virtual progression resources required for the requested progression level of the first virtual character based on the current progression level of the first virtual character;
determining, by the server and based on the current progression level of the first virtual character, the progression level of the first virtual character to be transmitted, and updating the current number of the virtual progression resources and the current progression level of the first virtual character, when the current number of the virtual progression resources of the first virtual character meets the required number of the virtual progression resources;
transmitting, by the server, the updated current number of the virtual progression resources and the updated current progression level of the first virtual character to the client; and
synchronizing, by the client, the current number of the virtual progression resources and the current progression level of the first virtual character at the client.

In some embodiments, the virtual reward resource includes audio track data, and synchronizing, by the client, the virtual reward resource at the client includes:
storing, by the client, each received audio track data for playing; and
superimposing, by the client, at least a portion of the received audio track data as combined audio track data, and storing the combined audio track data for playing.

In some embodiments, the virtual reward resource further includes image data and/or video data, and synchronizing, by the client, the virtual reward resource at the client further includes:
storing, by the client, each received image data and/or video data for display; and
superimposing, by the client, at least a portion of the received image data and/or video data as combined image data and/or video data, and storing the combined image data and/or video data for display.

In some embodiments, the method further includes:
sharing, by the client, the virtual reward resource with other clients.

Embodiments of the present disclosure further disclose a system for virtual resource interaction, including a client and a server. The client and the server are configured to implement the method for virtual resource interaction.

Embodiments of the present disclosure further disclose a computer-readable storage medium, on which a computer executable instruction is stored. The instruction is executed by a processor to implement the method for virtual resource interaction.

Embodiments of the present disclosure further disclose a computer program product, including a computer executable instruction. The instruction is executed by a processor to implement the method for virtual resource interaction.

### BRIEF DESCRIPTION OF THE DRAWINGS

FIG. 1 shows a schematic structural diagram of a system for virtual resource interaction according to an embodiment of the present disclosure.

FIG. 2 shows a flowchart of a method for virtual resource interaction according to an embodiment of the present disclosure.

FIG. 3 shows another flowchart of a method for virtual resource interaction according to an embodiment of the present disclosure.

### DETAILED DESCRIPTION OF THE EMBODIMENTS

To make the objectives and technical solutions of the embodiments of the present disclosure more clear, the following clearly and completely describes the technical solutions of the embodiments of the present disclosure with reference to the accompanying drawings of the embodiments of the present disclosure. Apparently, the embodiments to be described are only a part rather than all of the embodiments of the present disclosure, and based on the described embodiments of the present disclosure, all other embodiments obtained by persons of ordinary skill in the art without creative efforts shall belong to the scope of protection of the present disclosure.

Rewarding character progression can give the player a sense of achievement and enhance their enjoyment in playing the game. However, the applicant found that existing forms for rewarding character progression are tedious, offering a limited incentive to the player. The player easily becomes fatigued in the absence of the incentive, making it difficult to maintain a satisfying game experience. Additionally, the security and stability of existing reward distribution methods are poor, lacking enhanced data verification and data synchronization processes.

A first embodiment of the present disclosure relates to a system for virtual resource interaction.

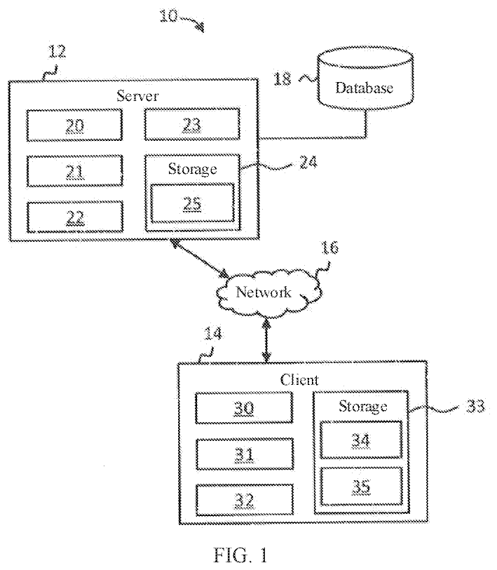

FIG. 1 shows a schematic structural diagram of a system for virtual resource interaction according to an embodiment of the present disclosure. As shown in FIG. 1, the system 10 for virtual resource interaction may include a server 12 and a client 14. The server 12 and the client 14 may communicate with each other via a network 16. The server 12 may be hosted and configured in a cloud, and may be coupled to a database 18.

The server 12 may be embodied as a single device or a group of devices. One or more of these devices may include one or more processors 20, a network interface 21, a user interface 22, a database interface 23, and a non-transitory computer-readable storage 24 having instructions 25 stored therein that are executable by the one or more processors 20. The instructions 25 can be executed by the one or more processors 20 to implement at least a portion of a method for virtual resource interaction to be described below.

The network interface 21 may be configured to communicate with the client 14 and other devices using any suitable protocol via the network 16 (such as a wide area network, local area network, or the like), and may include any suitable number of wired and/or wireless links.

The user interface 22 may include one or more input components (such as a touch screen, microphone, keyboard, or the like) and one or more output components (such as a screen, speaker, or the like).

The database interface 23 may be configured to transmit data to and receive data from the database 18. The database 18 may store server data (such as game data or the like).

The client 14 may be embodied as a desktop computer, a laptop computer, a tablet computer, and other types of portable devices (such as smart phones, wearable devices, or the like). More generally, the client 14 may be embodied as all suitable computing devices.

Similar to the network interface 21 in the server 12, the client 14 may include a network interface 31. The network interface 31 may be configured to communicate with the server 12 and other devices using any suitable protocol via the network 16 (such as a wide area network, local area network, or the like), and may include any suitable number of wired and/or wireless links.

The client 14 may also include one or more processors 30 and a non-transitory computer-readable storage 33 having instructions 34 stored therein that are executable by the one or more processors 30. The instructions 34 can be executed by the one or more processors 30 to implement at least a portion of a method for virtual resource interaction to be described below. In addition, the instructions 34 can also be executed by the one or more processors 30 to implement one or more game applications, and the non-transitory computer-readable storage 33 can also store client data 35 (such as game data or the like).

Additionally, similar to the user interface 22 in the server 12, the client 14 may include a user interface 32. The user interface 32 may include one or more input components (such as a touch screen, microphone, keyboard, or the like) and one or more output components (such as a screen, speaker, or the like).

A second embodiment of the present disclosure relates to a method for virtual resource interaction.

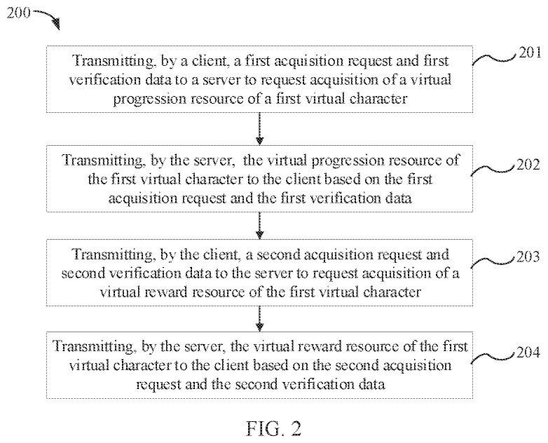

FIG. 2 shows a flowchart of a method for virtual resource interaction according to an embodiment of the present disclosure. As shown in FIG. 2, the method 200 for virtual resource interaction may include the following steps.

At block 201, the client transmits a first acquisition request to the server through the network via the network interface to request the server to transmit a virtual progression resource of a first virtual character to the client.

The first virtual character may be a certain hero-in-game in a certain game application that can be run on the client. A player of the client may own the first virtual character through various means such as system distribution, pulling virtual cards, completing game tasks, purchasing game packs, or the like, so that the player can control the first virtual character in the game application. It can be understood that as time progresses, the player may own a plurality of first virtual characters whose game attributes may be identical or substantially identical, and the plurality of first virtual characters may be duplicated for the player in view of reasons such as the limited types of virtual characters that the player can control at the same time.

The first virtual character may have a character progression function. For example, the first virtual character may have a progression level, and as the progression level upgrades, certain game attributes (such as health points, magic points, attack points, defensive points, or the like) of the first virtual character may be upgraded. In order to reduce the number of duplicate identical virtual characters owned by players, virtual progression resources may be set, and the number of the virtual progression resources may be associated with the number of corresponding virtual characters. In other words, the player can exchange the certain number of the first virtual characters for corresponding virtual progression resources associated with that first virtual character, and optionally utilize the certain number of virtual progression resources to upgrade the progression level.

As an example, the virtual character may be embodied as a hero-in-game card, the virtual progression resource may be embodied as a hero-in-game spirit stone, and the progression level may be embodied as a star class of a hero-in-game. The number of corresponding virtual characters required for a unit number of virtual progression resources can be fixed. For example, when the player owns two or more identical hero-in-game cards, each duplicate hero-in-game card can be exchanged for one corresponding hero-in-game spirit stone. The number of virtual progression resources required for upgrading a progression level can be fixed, or linearly or non-linearly changed with the upgrade of the progression level. For example, an upgrade of a progression level of a hero-in-game from one-star to two-star needs to consume one corresponding hero-in-game spirit stone, while an upgrade of the progression level of the hero-in-game from two-star to three-star needs to consume two or more corresponding hero-in-game spirit stones.

The client may record at least a part of the current number of the first virtual characters, the current number of the virtual progression resources of the first virtual characters, and the current progression level of the first virtual character, and store the same in the non-transitory computer-readable storage as the game data. It can be understood that part or all of the game data recorded and stored at the client can be uploaded to the server in real time, periodically or non-periodically (for example, after the player is offline), and the server can synchronize the game data and store the game data in the database through the database interface. In addition, the server may record a mapping relationship between the number of virtual characters and the number of corresponding virtual progression resources and a mapping relationship between the progression levels and the number of corresponding virtual progression resources, and store the mapping relationships in the database through the database interface as the game data.

In order to enhance the data verification and data synchronization processes, in addition to the first acquisition request, at block 201, the client further transmits first verification data to the server through the network via the network interface, so that the server can verify whether the virtual progression resource of the first virtual character should be transmitted to the client and can verify whether the current number of first virtual characters at the client and at the server remains consistent. The first verification data indicates the current number of first virtual characters at the client. The client may retrieve the current number of first virtual characters from the non-transitory computer-readable storage as the first verification data.

At block 202, the server receives the first acquisition request from the client through the network via the network interface, and parses the first acquisition request to determine that the client requested to acquire one or more virtual progression resources of the first virtual character. In addition to the first acquisition request, at block 202, the server further receives first verification data from the client through the network via the network interface, and parses the first verification data to determine the current number of first virtual characters recorded and stored at the client. Then, at block 202, the server transmits the virtual progression resource of the first virtual character to the client through the network via the network interface.

Specifically, the server retrieves the mapping relationship between the number of the first virtual characters and the number of corresponding virtual progression resources from the database through the database interface. Based on the first acquisition request and the first verification data, and based on the mapping relationship, the server verifies whether the current number of first virtual characters satisfies the number of first virtual characters required to request the virtual progression resource. In addition, in the case that the database stores the current number of first virtual characters, the server further retrieves the current number of first virtual characters from the database through the database interface and verifies whether the current number of first virtual characters at the client and at the server remains consistent.

When the current number of first virtual characters satisfies the number of first virtual characters required to request the virtual progression resource, and optionally when the current number of first virtual characters at the client and at the server remains consistent, the server determines the number of virtual progression resources to be transmitted and updates the current number of first virtual characters. It can be understood that, the updated current number of the first virtual characters should be equal to the current number of the first virtual characters before the update (i.e., the current number of the first virtual characters at the client indicated by the first verification data or the current number of the first virtual characters recorded at the server) minus the number of the first virtual characters required to exchange for the virtual progression resource to be transmitted. The server stores the updated current number of first virtual characters in the database through the database interface. In addition, in the case where the current number of the virtual progression resources of the first virtual characters is stored in the database, the server further updates the current number of the virtual progression resources of the first virtual characters and stores it in the database through the database interface as the game data. It can be understood that the updated current number of the virtual progression resources of the first virtual characters should be the sum of the current number of the virtual progression resources of the first virtual character before the update and the number of the virtual progression resources to be transmitted.

The server then transmits the virtual progression resource and the updated current number of first virtual characters to the client through the network interface. The client synchronizes the current number of virtual progression resources and the current number of first virtual characters at the client after the client receives the virtual progression resource and the updated current number of first virtual characters from the server through the network via the network interface. It can be understood that the current number of the synchronized virtual progression resources should be the sum of the current number of the virtual progression resources before the synchrony and the number of the received virtual progression resources, and the synchronized current number of the first virtual characters is the received updated current number of the first virtual characters, thereby at least ensuring that the current number of first virtual characters at the client and at the server remains consistent. In addition, in the case where the server updates the current number of virtual progression resources of the first virtual characters, the server further transmits the updated current number of virtual progression resources of the first virtual characters to the client through the network via the network interface, thereby ensuring that the current number of virtual progression resources of the first virtual characters at the client and at the server remains consistent.

As an example, when a player owns two identical hero-in-game cards, the player requests the server through the client to exchange one duplicate hero-in-game card for one corresponding hero-in-game spirit stone. In this case, the player shows the server through the client that the current number of the corresponding hero-in-game cards owned by the player is two. The client confirms that the number of cards satisfies the number of cards required to exchange for one corresponding game spirit stone (e.g., one hero-in-game card may be exchanged for one corresponding game spirit stone), and optionally the client further confirms that the current number of corresponding hero-in-game cards owned by the player remains consistent with the number of cards recorded and stored at the server. Based on this, the server transmits one corresponding hero-in-game spirit stone to the client, and at the same time notifies the client that the updated current number of corresponding hero-in-game cards should be one, so that the client can synchronize the current number of hero-in-game spirit stones and the current number of hero-in-game cards, and thus the player will own one hero-in-game card and one corresponding hero-in-game spirit stone.

At block 203, the client transmits a second acquisition request to the server through the network via the network interface to request the server to transmit a virtual reward resource of the first virtual character to the client.

With the progress of the virtual character, only upgrading certain game attributes of the virtual character may not sufficiently incentivize the player, the player is prone to feeling tired, and it is difficult to maintain a satisfying game experience. Based on this, the virtual reward resources for the virtual character can be designed, such as audio track data, image data and/or video data, etc.

The audio track data may include a plurality of types, and as the progression level of the virtual character upgrades, different types of audio track data may be sequentially unlocked, such as sequentially unlocking musical instrument sounds, electronic synthetic musical sounds, and human sounds. In addition, different virtual characters may correspond to different audio track data contents. The image data may include a portrait, skin, clothes, items of the virtual character, a scene where the virtual character is located, a static effect, or the like. Further, different virtual characters may correspond to different image data contents. The video data may include an action video and a dynamic effect of virtual characters, or the like, and different virtual characters may correspond to different video data contents.

In addition, the virtual reward resource may also include exclusive attributes and skills or the like specific to the virtual character.

As already described above, the virtual character may have a progression level, and the player may consume a certain number of virtual progression resources to upgrade the progression level. In this case, the type of virtual reward resource may be set to be associated with the progression level of the corresponding virtual character. In other words, as the progression level of the corresponding virtual character upgrades, different types of virtual reward resources corresponding to the virtual character may be sequentially unlocked. For example, an upgrade in the progression level of the hero-in-game from one-star to two-star may unlock musical instrument sounds of the corresponding hero-in-game, while an upgrade in the progression level of the hero-in-game from two-star to three-star may unlock electronic synthetic musical sounds of the corresponding hero-in-game.

The server may record a mapping relationship between the type of the virtual reward resource and the progression level of the corresponding virtual character, and store the mapping relationship as game data in a database through the database interface.

In order to enhance the data verification and data synchronization processes, in addition to the second acquisition request, at block 203, the client further transmits second verification data to the server through the network via the network interface, so that the server can verify whether the virtual reward resources of the first virtual character should be transmitted to the client, and can verify whether the current progression level of the first virtual character at the client and at the server remains consistent. The second verification data indicates a current progression level of the first virtual character at the client, and the client may retrieve the current progression level of the first virtual character from the non-transitory computer-readable storage as the second verification data.

At block 204, the server receives a second acquisition request from the client through the network via the network interface, parses the second acquisition request to determine that the client requested to acquire a type of virtual reward resource of the first virtual character. In addition to the second acquisition request, at block 204, the server further receives second verification data from the client through the network via the network interface, parses the second verification data to determine the current progression level of the first virtual character recorded and stored at the client. Then, at block 204, the server transmits the virtual reward resource of the first virtual character to the client through the network via the network interface.

Specifically, the server retrieves a mapping relationship between the type of virtual reward resource of the first virtual character and the progression level of the corresponding virtual character from the database through the database interface. Based on the second acquisition request and the second verification data, and based on the mapping relationship, the server verifies whether the current progression level of the first virtual character satisfies the progression level of the first virtual character required for the requested virtual reward resource. Further, in a case where the current progression level of the first virtual character is stored in the database, the server further retrieves the current progression level of the first virtual character from the database through the database interface, and verifies whether the current progression level of the first virtual character at the client and at the server remains consistent.

When the current progression level of the first virtual character satisfies the progression level of the first virtual character required for the requested virtual reward resource, and optionally when the current progression level of the first virtual character at the client and at the server remains consistent, the server determines the virtual reward resources of the first virtual character to be transmitted.

The server then transmits the virtual reward resources of the first virtual character through the network via the network interface to the client. After the client receives the virtual reward resource of the first virtual character from the server through the network via the network interface, the client synchronizes the virtual reward resource of the first virtual character at the client. It can be understood that the virtual reward resource of the first virtual character after synchronization should be the sum of the virtual reward resource of the first virtual character before synchronization and the received virtual reward resource of the first virtual character.

As an example, the player requests to acquire musical instrument sounds of the hero-in-game from the server through the client, and at this time, the player shows to the server through the client that the current progression level of the corresponding hero-in-game owned by the player is two-star. The client confirms that the musical instrument sounds correspond to the current progression level of the corresponding hero-in-game of two-star, and optionally, the client also confirms that the current progression level of the corresponding hero-in-game owned by the player remains consistent with the progression level recorded and stored at the server. Based on this, the server transmits a corresponding musical instrument of the hero-in-game to the client, so that the client can synchronize the current audio track data of the hero-in-game, and the player will own the musical instrument sounds of the hero-in-game.

It can be understood that, in addition to a character deduplication step of virtual character-virtual progression resource and a reward unlocking step of progression level-virtual reward resource, a level upgrading step of virtual progression resource-progression level may also be included.

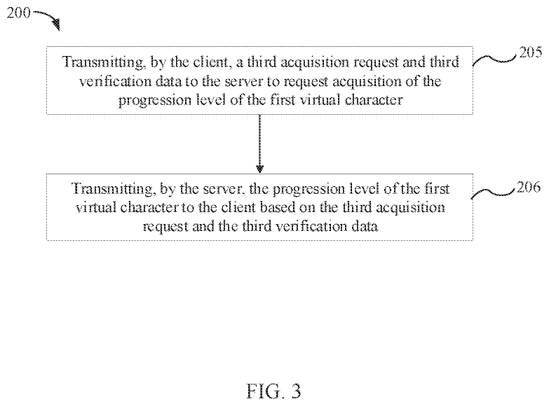

FIG. 3 shows another flowchart of the method for virtual resource interaction according to an embodiment of the present disclosure. As shown in FIG. 3, the method 200 for virtual resource interaction may further include the following steps.

At block 205, the client transmits a third acquisition request to the server through the network via the network interface to request the server to transmit the progression level of the first virtual character to the client.

In order to enhance data verification and data synchronization processes, in addition to the third acquisition request, at block 205, the client further transmits the third verification data to the server through the network via the network interface, so that the server can verify whether or not the progression level of the first virtual character should be transmitted to the client, and can verify whether the current number of virtual progression resources of the first virtual character and the current progression level of the first virtual character at the client and at the server remain consistent. The third verification data indicates the current number of virtual progression resources of the first virtual character and the current progression level of the first virtual character at the client. The client may retrieve the current number of virtual progression resources of the first virtual character and the current progression level of the first virtual character from the non-transitory computer-readable storage as the third verification data.

At block 206, the server receives the third acquisition request from the client through the network via the network interface, parses the third acquisition request to determine that the client requested to acquire the progression level of the first virtual character. In addition to the third acquisition request, at block 206, the server further receives third authentication data from the client through the network via the network interface, parses the third authentication data to determine the current number of virtual progression resources of the first virtual character and the current progression level of the first virtual character recorded and stored at the client. Then, at block 206, the server transmits the progression level of the first virtual character to the client through the network via the network interface.

Specifically, the server retrieves the mapping relationship between the progression level of the first virtual character and the number of corresponding virtual progression resources from the database through the database interface. Based on the third acquisition request and the third verification data, and based on the mapping relationship, the server verifies whether the current number of virtual progression resources of the first virtual character satisfies the number of virtual progression resources required for the requested progression level of the first virtual character. In addition, when the current number of the virtual progression resources of the first virtual character and the current progression level of the first virtual character are stored in the database, the server further retrieves the current number of virtual progression resources of the first virtual character and the current progression level of the first virtual character from the database through the database interface, and verifies whether the current number of virtual progression resources of the first virtual character and the current progression level of the first virtual character at the client and at the server remain consistent.

Based on the current progression level of the first virtual character, when the current number of virtual progression resources of the first virtual character satisfies the number of virtual progression resources required for the requested progression level of the first virtual character, and optionally when the current number of virtual progression resources of the first virtual character and the current progression level of the first virtual character at the client and at the server remain consistent, the server determines the progression level of the first virtual character to be transmitted, and updates the current number of virtual progression resources and the current progression level of the first virtual character. In a case where the current number of the virtual progression resources of the first virtual character and the current progression level of the first virtual character are stored in the database, the server further stores the updated current number of the virtual progression resources of the first virtual character and the updated current progression level of the first virtual character in the database as the game data via the database interface. It can be understood that the updated current number of the virtual progression resources of the first virtual character should be equal to the current number of virtual progression resources of the first virtual character before the update (i.e., the current number of virtual progression resources of the first virtual character at the client indicated by the third verification data or recorded at the server) minus the number of virtual progression resources of the first virtual character required to exchange for the progression level to be transmitted. The updated current progression level of the first virtual character is the progression level of the first virtual character to be transmitted.

Then, the server transmits the updated current number of virtual progression resources and the updated current progression level of the first virtual character to the client through the network via the network interface. After the client receives the updated current number of virtual progression resources and the updated current progression level of the first virtual character from the server through the network via the network interface, the client synchronizes the current number of virtual progression resources and the current progression level of the first virtual character at the client. It can be understood that the current number of the synchronized virtual progression resources is the received updated current number of the virtual progression resources, and the synchronized current progression level of the first virtual character is the received updated current progression level of the first virtual character, thereby ensuring that at least the current number of virtual progression resources and the current progression level of the first virtual character at the client remain consistent with the current number of virtual progression resources and the current progression level of the first virtual character at the server.

As an example, the player requests the server through the client to upgrade the progression level of the hero-in-game to two-star. At this time, the player shows to the server through the client that the current number of the corresponding hero-in-game spirit stones owned by the player is one and the current progression level of the corresponding hero-in-game is one-star. The client confirms that the number of spirit stones satisfies the number of the spirit stones required to upgrade the corresponding hero-in-game to a progression level of two-star (for example, upgrading the hero-in-game from one-star to two-star requires consuming one corresponding hero-in-game spirit stone). Optionally, the client also confirms that the current number of corresponding hero-in-game spirit stones owned by the player and the current progression level of the corresponding hero-in-game are consistent with the number of the spirit stones and progression level recorded and stored at the server. Based on this, the server notifies the client that the updated current number of corresponding hero-in-game spirit stones should be zero and the current progression level of the corresponding hero-in-game should be two-star, so that the client can synchronize the current number of hero-in-game spirit stones and the current progression level of the hero-in-game, and thus the player will have no corresponding hero-in-game spirit stone and a corresponding hero-in-game of the two-star.

As already described above, the virtual reward resource includes audio track data, image data and/or video data, etc.

When the virtual reward resource is audio track data, the client stores each received audio track data for playing, and superimposes and stores at least a part of the received audio track data as combined audio track data for playing. As an example, when the player has audio track data in the form of a bell, drum, guitar, bass, piano, and human voice of a certain hero-in-game, these audio track data may be played separately, or may be played at least partially in combination, so that the number of virtual reward resources collected by the player may be reflected, and with the increase of the number, the display effect may be more diverse and intricate.

When the virtual reward resources are image data and/or video data, the client stores each of the received image data and/or video data for display, and superimposes and stores at least a portion of the received image data and/or video data as combined image data and/or video data for display. As an example, when a player owns the skin, clothes, scene and dynamic effects of a certain hero-in-game, these image data and video data may be displayed separately, or may be displayed at least partially in combination, so that the number of virtual reward resources collected by the player may be reflected, and with the increase of the number, the display effect may be more diverse and intricate.

In addition, after the client synchronizes the virtual reward resource, the client shares the virtual reward resource with other clients through the network via the network interface. Depending on the storage mechanism and the sharing mechanism at the client, the sharing may occur within a gaming application or across different applications, and other clients may or may not download, store, use and/or edit the virtual reward resource.

As an example, when a player owns multiple audio track data of a certain hero-in-game, the audio track data is stored at the client in a music format specific to the game application and shared with other clients in a link format specific to the game application. In this case, the audio track data can be played by clicking the link on the other clients and starting the game application on the other clients. Additionally, through data protection techniques, the other clients cannot download, store, use, and/or edit these audio track data.

As another example, when a player owns portrait data for a certain hero-in-game, the portrait data is stored at the client in a common image format and shared with other clients in that image format. In this case, other clients can display the portrait data on the generic image display application and can download, store, use and/or edit the portrait data.

The present disclosure further provides a computer-readable storage medium, on which a computer-executable instruction is stored, and the instruction is executed by a processor to implement the method for virtual resource interaction described in the second embodiment of the present disclosure.

The present disclosure further provides a computer program product. The computer program product includes a computer executable instruction. The instruction is executed by a processor to implement the method for virtual resource interaction described in the second embodiment of the present disclosure.

Comparing the embodiments of the present disclosure with the conventional technology, the main differences and effects thereof lie the following.

According to the present disclosure, the client transmits verification data to the server, the server transmits updated data to the client, and the client synchronizes the updated data, so that the data verification and data synchronization processes can be enhanced. In addition, the present disclosure devises virtual reward resources, which can reflect the number of virtual reward resources collected by the player. Furthermore, as the number increases, display effect can be more diverse and intricate, thereby improving the incentive for the player, and providing the satisfying game experience.

It should be noted that, each method embodiment of the present disclosure may be implemented by software, hardware, firmware, or the like. Regardless of whether the present disclosure is implemented in software, hardware, or firmware, the instruction code may be stored in any type of computer-accessible memory (e.g., permanent or modifiable, transitory or non-transitory, solid-state or non-solid-state, fixed or removable medium, or the like). Similarly, the memory may be, for example, programmable array logic (PAL), random access memory (RAM), programmable read only memory (PROM), read-only memory (ROM), electrically erasable programmable read only memory (EEPROM), magnetic disk, optical disk, digital versatile disk (DVD), or the like.

It should be noted that all units/modules mentioned in the device embodiments of the present disclosure are logical units/modules. Physically, a logical unit may be a physical unit or a part of a physical unit, it can also be realized by a combination of a plurality of physical units. The physical realization of these logical units themselves is not the most important, and the combination of functions realized by these logic units is the key to solving the technical problem proposed by the present disclosure. In addition, in order to highlight the inventive part of the present disclosure, the above-described device embodiments of the present disclosure do not introduce units that are not closely related to solving the technical problem proposed by the present disclosure, which does not indicate that the described device embodiments do not have other units.

In the drawings, some structural or method features may be shown in specific arrangements and/or orders. However, it should be understood that such specific arrangements and/or ordering may not be required. Rather, in some embodiments, the features may be arranged in a different manner and/or order than shown in the illustrative drawings. In addition, the inclusion of structural or method features in a particular figure is not meant to imply that such features are required in all embodiments, and in some embodiments may not be included or may be combined with other features.

It should be noted that, in the claims and description of the present patent, terms such as first and second are merely used to distinguish one entity or operation from another entity or operation, and do not necessarily require or imply any actual relationship or sequence between these entities or operations. Furthermore, the terms “include”, “comprise”, or any other variant thereof are intended to cover a non-exclusive inclusion, so that a process, a method, an object, or a device that includes a series of elements not only includes those elements, but also includes other elements that are not explicitly listed, or further includes elements inherent to the process, the method, the article, or the device. An element limited by “including one” does not, without more constraints, doses no exclude the existence of additional identical elements in the process, method, object, or device that includes the element.

Although the present disclosure has been illustrated and described with reference to some preferred embodiments of the present disclosure, it should be understood by those skilled in the art that various changes in form and details may be made therein without departing from the spirit and scope of the present disclosure. What is claimed is:

1. A method for virtual resource interaction, comprising:
transmitting, by a client, a first acquisition request and first verification data to a server to request acquisition of a virtual progression resource of a first virtual character;
transmitting, by the server, the virtual progression resource of the first virtual character to the client based on the first acquisition request and the first verification data;
transmitting, by the client, a second acquisition request and second verification data to the server to request acquisition of a virtual reward resource of the first virtual character; and
transmitting, by the server, the virtual reward resource of the first virtual character to the client based on the second acquisition request and the second verification data.

2. The method of claim 1, wherein the first verification data indicates a current number of the first virtual characters at the client, and transmitting, by the server, the virtual progression resource of the first virtual character to the client comprises:
verifying, by the server, whether the current number of the first virtual characters satisfies a number of the first virtual characters required for the request virtual progression resource;
determining, by the server, a number of the virtual progression resources to be transmitted and updating the current number of the first virtual characters when the current number of the first virtual characters satisfies the number of the first virtual characters required;
transmitting, by the server, the virtual progression resource and the updated current number of the first virtual character to the client; and
synchronizing, by the client, the current number of the virtual progression resources and the current number of the first virtual characters at the client.

3. The method of claim 2, wherein the second verification data indicates a current progression level of the first virtual character at the client, and transmitting, by the server, the virtual reward resource of the first virtual character to the client comprises:
verifying, by the server, whether the current progression level of the first virtual character satisfies the progression level of the first virtual character required for the requested virtual reward resource;
determining, by the server, the virtual reward resource to be transmitted when the current progression level of the first virtual character satisfies the progression level of the first virtual character required;
transmitting, by the server, the virtual reward resource to the client; and
synchronizing, by the client, the virtual reward resource at the client.

4. The method of claim 3, further comprising:
transmitting, by the client, a third acquisition request and third verification data to the server to request acquisition of the progression level of the first virtual character; and
transmitting, by the server, the progression level of the first virtual character to the client based on the third acquisition request and the third verification data.

5. The method of claim 4, wherein the third verification data indicates the current number of the virtual progression resources of the first virtual character at the client and the current progression level of the first virtual character, and transmitting, by the server, the progression level of the first virtual character to the client comprises:
verifying, by the server, whether the current number of the virtual progression resources of the first virtual character satisfies the number of the virtual progression resources required for the requested progression level of the first virtual character based on the current progression level of the first virtual character;
determining, by the server and based on the current progression level of the first virtual character, the progression level of the first virtual character to be transmitted, and updating the current number of the virtual progression resources and the current progression level of the first virtual character, when the current number of the virtual progression resources of the first virtual character satisfies the required number of the virtual progression resources;
transmitting, by the server, the updated current number of the virtual progression resources and the updated current progression level of the first virtual character to the client; and
synchronizing, by the client, the current number of the virtual progression resources and the current progression level of the first virtual character at the client.

6. (canceled)

7. The method of claim 22, wherein the virtual reward resource further comprises image data and/or video data, and synchronizing, by the client, the virtual reward resource at the client further comprises:
storing, by the client, each received image data and/or video data for display; and
superimposing, by the client, at least a portion of the received image data and/or video data as combined image data and/or video data, and storing the combined image data and/or video data for display.

8. The method of claim 1, further comprising:
sharing, by the client, the virtual reward resource with other clients.

9-11. (canceled)

12. The method of claim 2, wherein a database coupled with the server stores the current number of first virtual characters, and the method further comprises:
retrieving, by the server, the current number of first virtual characters from the database;
verifying, by the server, whether the current number of first virtual characters at the client and at the server remains consistent; and
determining, by the server, the number of the virtual progression resources to be transmitted and updating the current number of the first virtual characters when the current number of the first virtual characters satisfies the number of the first virtual characters required and when the current number of first virtual characters at the client and at the server remains consistent.

13. The method of claim 3, the database further stores the current progression level of the first virtual character, the method further comprises:
retrieving, by the server, the current progression level of the first virtual character from the database;
verifying, by the server, whether the current progression level of the first virtual character at the client and at the server remains consistent; and
determining, by the server, the virtual reward resource to be transmitted when the current progression level of the first virtual character satisfies the progression level of the first virtual character required and when the current progression level of the first virtual character at the client and at the server remains consistent.

14. The method of claim 5, wherein the database stores the current number of the virtual progression resources of the first virtual character and the current progression level of the first virtual character, and the method further comprises:
retrieving, by the server, the current number of virtual progression resources of the first virtual character and the current progression level of the first virtual character from the database;
verifying, by the server, whether the current number of virtual progression resources of the first virtual character and the current progression level of the first virtual character at the client and at the server remain consistent; and
determining, by the server and based on the current progression level of the first virtual character, the progression level of the first virtual character to be transmitted, and updating the current number of the virtual progression resources and the current progression level of the first virtual character, when the current number of the virtual progression resources of the first virtual character satisfies the required number of the virtual progression resources, and when the current number of virtual progression resources of the first virtual character and the current progression level of the first virtual character at the client and at the server remain consistent.

15. A system for virtual resource interaction, comprising a client and a server, wherein the client and the server are configured to implement operations for virtual resource interaction, the operations comprising:
transmitting, by the client, a first acquisition request and first verification data to the server to request acquisition of a virtual progression resource of a first virtual character;
transmitting, by the server, the virtual progression resource of the first virtual character to the client based on the first acquisition request and the first verification data;
transmitting, by the client, a second acquisition request and second verification data to the server to request acquisition of a virtual reward resource of the first virtual character; and
transmitting, by the server, the virtual reward resource of the first virtual character to the client based on the second acquisition request and the second verification data.

16. The system according to claim 15, wherein the first verification data indicates a current number of the first virtual characters at the client, and transmitting, by the server, the virtual progression resource of the first virtual character to the client comprises:
verifying, by the server, whether the current number of the first virtual characters satisfies a number of the first virtual characters required for the request virtual progression resource;
determining, by the server, a number of the virtual progression resources to be transmitted and updating the current number of the first virtual characters when the current number of the first virtual characters satisfies the number of the first virtual characters required;
transmitting, by the server, the virtual progression resource and the updated current number of the first virtual character to the client; and
synchronizing, by the client, the current number of the virtual progression resources and the current number of the first virtual characters at the client.

17. The system of claim 16, wherein the second verification data indicates a current progression level of the first virtual character at the client, and transmitting, by the server, the virtual reward resource of the first virtual character to the client comprises:
verifying, by the server, whether the current progression level of the first virtual character satisfies the progression level of the first virtual character required for the requested virtual reward resource;
determining, by the server, the virtual reward resource to be transmitted when the current progression level of the first virtual character satisfies the progression level of the first virtual character required;
transmitting, by the server, the virtual reward resource to the client; and
synchronizing, by the client, the virtual reward resource at the client.

18. The system of claim 17, wherein the operations further comprise:
transmitting, by the client, a third acquisition request and third verification data to the server to request acquisition of the progression level of the first virtual character; and
transmitting, by the server, the progression level of the first virtual character to the client based on the third acquisition request and the third verification data.

19. The system according to claim 18, wherein the third verification data indicates the current number of the virtual progression resources of the first virtual character at the client and the current progression level of the first virtual character, and transmitting, by the server, the progression level of the first virtual character to the client comprises:
verifying, by the server, whether the current number of the virtual progression resources of the first virtual character satisfies the number of the virtual progression resources required for the requested progression level of the first virtual character based on the current progression level of the first virtual character;
determining, by the server and based on the current progression level of the first virtual character, the progression level of the first virtual character to be transmitted, and updating the current number of the virtual progression resources and the current progression level of the first virtual character, when the current number of the virtual progression resources of the first virtual character satisfies the required number of the virtual progression resources;
transmitting, by the server, the updated current number of the virtual progression resources and the updated current progression level of the first virtual character to the client; and
synchronizing, by the client, the current number of the virtual progression resources and the current progression level of the first virtual character at the client.

20. The system according to claim 17, wherein the virtual reward resource comprises audio track data, and synchronizing, by the client, the virtual reward resource at the client comprises:
storing, by the client, each received audio track data for playing; and
superimposing, by the client, at least a portion of the received audio track data as combined audio track data, and storing the combined audio track data for playing.

21. The system according to claim 20, wherein the virtual reward resource further comprises image data and/or video data, and synchronizing, by the client, the virtual reward resource at the client further comprises:
storing, by the client, each received image data and/or video data for display; and
superimposing, by the client, at least a portion of the received image data and/or video data as combined image data and/or video data, and storing the combined image data and/or video data for display.

22. The method of claim 3, wherein the virtual reward resource comprises audio track data, and synchronizing, by the client, the virtual reward resource at the client comprises:
storing, by the client, each received audio track data for playing; and
superimposing, by the client, at least a portion of the received audio track data as combined audio track data, and storing the combined audio track data for playing.

23. A non-transitory computer-readable storage medium, on which a computer executable instruction is stored, wherein the instruction is executed by a processor to implement the method for virtual resource interaction according to claim 1.

24. A computer program product, comprising a computer executable instruction, wherein the instruction is executed by a processor to implement the method for virtual resource interaction according to claim 1.
